(19) United States
(12) Patent Application Publication
(10) Pub. No.: US 2006/0274449 A1
(43) Pub. Date: Dec. 7, 2006

(54) Magnetic recording medium defining a recording surface having improved smoothness characteristics

(75) Inventors: Bruce H. Edwards, White Bear Lake, MN (US); Adam A. Brodd, Minneapolis, MN (US)

Correspondence Address: Attention: Eric D. Levinson;Imation Corp., Legal Affairs, P.O. Box 64898, St. Paul, MN, 55164-0898, US

(73) Assignee: Imation Corp., St. Paul, MN (US)

(21) Appl. No.: 11/143,014

(22) Filed: Jun. 1, 2005

(51) Int. Cl. G11B 5/82

(52) U.S. Cl. 360/135

(57) ABSTRACT

A magnetic recording medium includes a substrate, a support layer, and a magnetic recording layer. The substrate defines a first surface. The support layer is formed over the first surface of the substrate. The magnetic recording layer is formed over the support layer and has a resistivity less than about 1×10⁸ ohms/square. The magnetic recording layer defines a recording surface opposite the support layer. The recording surface has an average roughness of less than about 2.5 nm.

### THE FIELD OF THE INVENTION

The present invention relates to magnetic recording media, such as magnetic recording tapes, defining a recording surface with improved smoothness characteristics.

### BACKGROUND

Magnetic recording media are widely used in audio tapes, video tapes, computer tapes, disks and the like. Magnetic recording media may use thin, metal layers as the recording layers, or many comprise particulate magnetic compounds as the recording layer. The latter type of magnetic recording media employs particulate material such as ferromagnetic iron oxides, chromium oxides, ferromagnetic alloy powders, and the like, dispersed in binders and coated on a substrate.

In general terms, magnetic recording media generally comprise a magnetic layer coated onto at least one side of a non-magnetic substrate (e.g., a film for magnetic recording tape applications). In certain designs, the magnetic coating is formed as a single layer directly onto the non-magnetic substrate. In an alternative approach, a dual-layer construction is employed, including a lower support layer on the substrate and a thin magnetic recording layer on the lower support layer. The two layers may be formed simultaneously or sequentially. With this type of construction, the lower support layer is generally thicker than the magnetic layer.

The support layer is typically non-magnetic and generally comprised of a non-magnetic powder dispersed in a binder. Conversely, the magnetic recording layer comprises one or more magnetic metal particle powders or pigments dispersed in a binder system. With this in mind, the magnetic recording layer defines a recording surface and is configured to record and store information.

Magnetic tapes may also have a backside coating applied to the opposing side of the non-magnetic substrate in order to improve the durability, electro-conductivity, and tracking characteristics of the media. The backside coatings are typically combined with a suitable solvent to create a homogeneous mixture which is then coated onto the substrate. The coated substrate is dried, calendered if desired, and cured. The formulation for the backside coating also comprises pigments in a binder system.

### SUMMARY

One aspect of the present invention relates to a magnetic recording medium including a substrate, a support layer, and a magnetic recording layer. The substrate defines a first surface. The support layer is formed over the first surface of the substrate. The magnetic recording layer is formed over the support layer and has a resistivity less than about 1×10⁸ ohms/square. The magnetic recording layer defines a recording surface opposite the support layer. The recording surface has an average roughness of less than about 2.5 nm.

Another aspect of the present invention relates to a magnetic recording medium including a substrate, a support layer, and a magnetic recording layer. The substrate defines a first surface. The support layer is formed over the first surface of the substrate. The magnetic recording layer is formed over the support layer and has a resistivity less than about 1×10⁸ ohms/square. The magnetic recording layer defines a recording surface opposite the support layer. The recording surface has an average surface peak-to-valley roughness of less than about 35 nm.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a schematic illustration of a cross-sectional view of one embodiment of a magnetic recording medium.

### DETAILED DESCRIPTION

In the following detailed description, specific embodiments are described in which the invention may be practiced. It is to be understood that other embodiments may be utilized and structural or logical changes may be made without departing from the scope of the present invention. The following detailed description, therefore, describes certain embodiments and is not to be taken in a limiting sense. The scope of the present invention is defined by the appended claims.

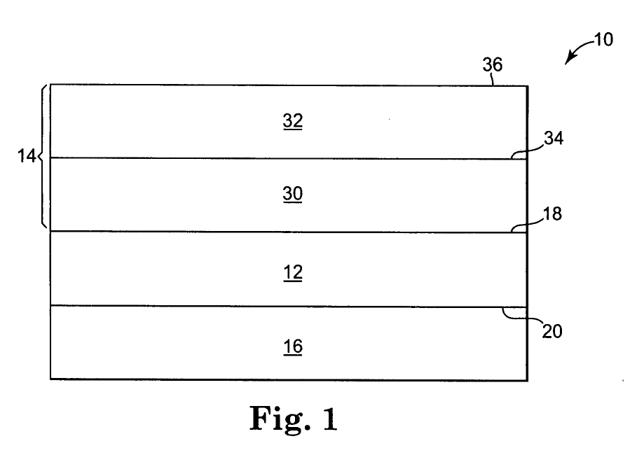

Turning to the figures, FIG. 1 illustrates a schematic, cross-sectional view of a magnetic recording medium 10. The magnetic recording medium 10 generally includes a substrate 12, a magnetic side 14, and a backcoat or backside 16. The substrate 12 defines a first or top surface 18 and a back or bottom surface 20 opposite top surface 18. The magnetic side 14 generally extends over and is bonded to top surface 18 of the substrate 12. The magnetic side 14 provides the recordable material to the magnetic recording medium 10. The backside 16 generally extends under and is bonded to the bottom surface 20 of the substrate 12. The backside 16 generally provides support for the magnetic recording medium 10. In one embodiment, the magnetic recording medium 10 is a magnetic recording tape.

The magnetic recording medium 10 according to embodiments of the present invention generally provides for improved signal-to-noise ratios and decreased error rate properties as compared to conventional media, particularly when used in high data density applications using narrow track width recording and reading magnetic recording heads. More specifically, the magnetic recording medium 10 exhibits improved SkirtSNR and BBSNR and decreases the occurrence of small and large dropouts at high densities.

The term “SkirtSNR” refers to “Skirt Signal-to-Noise Ratio” and is a measure of the modulation noise when observing noise sources at frequencies close to the fundamental write frequency of the magnetic recording medium. SkirtSNR is typically measured by comparing the peak signal power and the integrated noise power within 102 megahertz of the fundamental write frequency of the magnetic recording medium. One example method of measuring SkirtSNR is described in ECMA International Standard 319.

The term “BBSNR” refers to “Broad Band Signal-to-Signal Noise Ratio,” which is the ratio of the average signal power to the average integrated broad noise power of a magnetic recording medium clearly written at the test recording density. BBSNR specifically measures the area under the frequency curve from 4.5 kHz to 15.8 kHz. One example method of measuring BBSNR is described in ECMA International Standard 319.

Dropouts generally refer to areas of a recorded magnetic recording medium where the signal level read from the magnetic recording medium is less than the expected signal level based on a known signal previously recorded to that same area of the magnetic recording medium. As such, a dropout is essentially a defect area on the magnetic recording medium. Long dropouts refer to dropouts of 4 or more bits in length at the fundamental write frequency of the magnetic recording medium. Small dropouts refer to dropouts that are 3 or less bits in length at the fundamental write frequency of the magnetic recording medium. One example method of measuring dropouts is defined in ECMA International Standard 319. Per that method, dropouts are typically measured with a 10 μm head at a 35% threshold. However, for purposes of this application, dropouts are measured at a threshold of 55% on a reel-to-reel tester equipped with a 10 μm read/write head to approximate about a 6.9 μm read/write head. Use of a 6.9 μm head or other sized heads at thresholds approximating about a 6.9 μm head are also acceptable.

The Substrate

The substrate 12 can be any conventional non-magnetic substrate useful as a magnetic recording medium support. Examples of substrate materials useful for the magnetic recording medium 10 include polyesters such as polyethylene terephthalate (PET), polyethylene naphthalate (PEN), a mixture of polyethylene terephthalate and polyethylene naphthalate; polyolefins (e.g., polypropylene); cellulose derivatives; polyamides; and polyimides. In one example, polyethylene terephthalate or polyethylene naphthalate is preferably employed as the substrate 12. In general, the substrate 12 is in elongated tape form or configured to subsequently be cut into elongated tape form.

The Magnetic Side

In one embodiment, the magnetic side 14 is formed of dual-layer construction. Accordingly, the magnetic side 14 includes a support or lower layer 30 and a magnetic recording or upper layer 32. The support layer 30 extends over and is bonded to the top surface 18 of the substrate 12. The support layer 30 defines a top surface 34 opposite the substrate 12. The magnetic recording layer 32 extends over and is bonded to the top surface 34 of the support layer 30. As such, the magnetic recording layer 32 defines an outer or recording surface 36 opposite the support layer 30. The terms “layer” and “coating” are used interchangeably herein to refer to a coated composition.

The Support Layer

The composition making up the support layer 30 includes at least a primary pigment material and conductive carbon black and is essentially non-magnetic. Accordingly, the primary pigment material includes a non-magnetic or soft magnetic powder. As used herein, the term “soft magnetic powder” refers to a magnetic powder having a coercivity of less than about 23.9 kA/m (300 Oe). By forming the support layer 30 to be essentially non-magnetic, the electromagnetic characteristics of the magnetic recording layer 32 are not substantially adversely affected. However, to the extent that no substantial adverse effect is caused, the support layer 30 may contain a small amount of magnetic powder. In one embodiment, the primary pigment material consists of particular material, or “particle” selected from a non-magnetic particles, such as iron oxides, titanium dioxide, titanium monoxide, alumina, tin oxide, titanium carbide, silicon carbide, silicon dioxide, silicon nitride, boron nitride, etc., and soft magnetic particles. Optionally, these primary pigment materials are provided in a form coated with carbon, tin, or other electro-conductive material.

In one embodiment, the primary pigment material is formed of a non-magnetic α-iron oxide, which can be acidic or basic in nature. In one example, the non-magnetic α-iron oxides are substantially uniform in particle size, or are a metal-use starting material that is dehydrated by heating, and annealed to reduce the number of pores. After annealing, the primary pigment material is ready for surface treatment, which is generally performed prior to mixing with other materials in the support layer 30 (e.g., the carbon black, etc.). In one embodiment, the particle length of non-magnetic a-iron oxides or other primary pigment particles is less than 150 nm, preferably less than 120 nm. In one example, the α-iron oxides or other primary pigment particles are included in the support layer 30 with a volume concentration of greater than about 40%, preferably greater than about 40%. α-iron oxides are well known and are commercially available from companies such as Dowa Mining Company Ltd. of Tokyo, Japan; Toda Kogyo Corp. of Hiroshima, Japan; and Sakai Chemical Industry Co. of Osaka, Japan. In one embodiment, the primary pigment material has an average particle size of less than about 0.25 μm, more preferably less than about 0.15 μm.

The conductive carbon black material provides a certain level of conductivity so as to prohibit the magnetic recording layer 32 from charging with static electricity and provides additional compressibility to the magnetic side 14. The conductive carbon black material is preferably of a conventional type and is widely commercially available. In one embodiment, the conductive carbon black material has an average particle size of less than about 20 nm, more preferably about 15 nm. In one example where the primary pigment material is provided in a form coated with carbon, tin or other electroconductive material, the conductive carbon black is added in amounts from about 1 to about 5 parts by weight, more preferably from about 1.5 to about 3.5 parts by weight, based on 100 parts by weight of the primary pigment material. In one example where the primary pigment material is provided without a coating of electroconductive material, the conductive carbon black is added in amounts of from about 4 to about 10 parts by weight, more preferably from about 5 to about 8 parts by weight, based on 100 parts by weight of the primary pigment material. The total amount of conductive carbon black and electroconductive coating material in the support layer 30 is preferably sufficient to contribute to providing a resistivity of the magnetic side 14 at or below about 1×10⁸ ohm/cm², preferably at or below 5×10⁷ ohms/cm².

The support layer 30 can also include additional pigment components such as an abrasive or head cleaning agent (HCA). In one embodiment, the head cleaning agent component is aluminum oxide. Other abrasive grains, such as silica, ZrO₂, Cr₂O₃, etc., can also be employed as at least part of the head cleaning agent.

In one embodiment, the binder system associated with the support layer 30 incorporates at least one binder resin, such as-a thermoplastic resin, in conjunction with other resin components such as binders and surfactants used to disperse the head cleaning agent, a surfactant (or wetting agent), and one or more hardeners. In one embodiment, the binder system of the support layer 30 includes a combination of a primary polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like.

In one embodiment, the vinyl resin is a nonhalogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. One example of a nonhalogenated vinyl copolymer is a copolymer of monomers comprising 5 to 40 parts by weight of methacrylonitrile, 30 to 80 parts by weight of one or more nonhalogenated, nondispersing, vinyl monomers, 5 to 30 parts by weight of a nonhalogenated hydroxyl functional, vinyl monomer, and 0.25 to 10 parts by weight of a nonhalogenated, vinyl monomer bearing a dispersing group.

Examples of useful polyurethanes include polyester-polyurethane, polyether-polyurethane, polycarbonate-polyurethane, polyester-polycarbonate-polyurethane, and polycaprolactone-polyurethane. Other resins such as bisphenol-A epoxide, styrene-acrylonitrile, and nitrocellulose are also acceptable for use in the support layer binder system.

In one embodiment, a primary polyurethane binder is incorporated into the support layer 30 in amounts of from about 4 to about 10 parts by weight, and preferably from about 6 to about 8 parts by weight, based on 100 parts by weight of the primary pigment material. In one embodiment, the vinyl binder or vinyl chloride binder is incorporated into the support layer 30 in amounts from about 7 to about 15 parts by weight, and preferably from about 10 to about 12 parts by weight, based on 100 parts by weight of the primary pigment material.

In one embodiment, the binder system of the support layer 30 further includes a head cleaning agent binder used to disperse the selected head cleaning agent material, such as a polyurethane binder in conjunction with a pre-dispersed or paste head cleaning agent. Alternatively, other head cleaning agent binders compatible with the selected head cleaning agent format (e.g., powder head cleaning agent) may be utilized.

The binder system may also contain a surface treatment agent. In one embodiment, the surface treatment agent is a known surface treatment agent, such as phenylphosphonic acid (PPA), 4-nitrobenzoic acid, and various other adducts of sulfuric, sulfonic, phosphoric, phosphonic, and carboxylic acids. In one embodiment, the binder system also contains a hardening agent such as isocyanate or polyisocyanate. In one example, the hardener component is incorporated into the support layer 30 in amounts of from about 2 to about 5 parts by weight, and preferably from about 3 to about 4 parts by weight, based on 100 parts by weight of the primary support layer pigment.

In one embodiment, the support layer 30 further contains one or more lubricants such as a fatty acid and/or a fatty acid ester. The incorporated lubricant(s) exist throughout the magnetic side 14 and, importantly, at the recording surface 36 of the magnetic recording layer 32. The lubricant(s) reduces friction to maintain smooth contact with low drag, and protects the media surface from wear. Thus, in one example the lubricant(s) provided in both the support layer 30 and the magnetic recording layer 32 are selected and formulated in combination.

In one embodiment, the support layer 30 includes stearic acid that is at least 90% pure as the fatty acid. Although technical grade acids and/or acid esters can also be employed for the lubricant component, incorporation of high purity lubricant materials generally ensures robust performance of the resultant medium. Alternatively, other acceptable fatty acids include myristic acid, palmitic acid, oleic acid, etc., and their mixtures. The formulation of the support layer 30 can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination. In one embodiment, the lubricant is incorporated into the support layer 30 in an amount of from about 1 to about 10 parts by weight, and preferably from about 1 to about 5 parts by weight, based on 100 parts by weight of the primary pigment material.

The materials for the support layer 30 are mixed with the surface treated primary pigment, and the support layer 30 is coated to the substrate 12. In one embodiment, solvents are mixed with or otherwise associated with the support layer 30 to form the coating material of the support layer 30. In one example, the solvents include cyclohexanone (CHO) with a concentration in the range of about 5% and about 50%, methyl ethyl ketone (MEK) with a concentration in the range of about 30% and about 90%, and toluene (Tol) with a concentration in the range of about 0% and about 40%. Alternatively, other solvents or solvent combinations including, for example, xylene, tetrahydrofuran, methyl isobutyl ketone, and methyl amyl ketone, are associated with the coating material of the support layer 30.

The Magnetic Recording Layer

In one embodiment, the magnetic recording layer 32 includes a dispersion of magnetic pigments, an abrasive or head cleaning agent (HCA), a binder system, one or more lubricants, and/or a conventional surfactant or wetting agent. The components of the magnetic recording layer 32 are combined to form magnetic recording layer 32 with the desired properties, for example, to increase the signal-to-noise ratio and to decrease the error rates of the magnetic recording medium 10. In one embodiment, the volume concentration of the magnetic pigments in the magnetic recording layer is greater than about 35%, preferably, greater than about 40%.

The magnetic pigments have a composition including, but not limited to, metallic iron and/or alloys of iron with cobalt and/or nickel, and magnetic or non-magnetic oxides of iron, other elements, or mixtures thereof, which will hereinafter be referred to as metal particles. Alternatively, the metal particles can be composed of hexagonal ferrites such as barium ferrites.

In one embodiment, the metal particles have an average long axis length of less than about 75 nm, preferably less than about 50 nm. In one embodiment, the average length of the metal particles utilized in the magnetic recording layer 32 are less than or equal to about 45 nm.

“Coercivity” and “magnetic coercivity” are synonymous, are abbreviated Hc, and refer to the intensity of the magnetic field needed to reduce the magnetization of a ferromagnetic material (in this case the magnetic recording layer 32) to zero after the material has reached magnetic saturation. Use of metal particles with relatively high coercivity with a high volume of concentration within the magnetic recording layer 32 causes the magnetic recording medium 10 to exhibit a significantly narrowed pulsewidth, when measured by recording a signal on the magnetic recording medium 10 at a sufficiently low density that the transitions are isolated from one another (i.e., they do not interact or interfere with one another). In one embodiment, the magnetic pigment utilized in the magnetic recording medium has a coercivity greater than about 183 kA/m (2300 Oe), preferably greater than about 191 kA/m (2400 Oe).

The magnetic recording layer 32 may also include carbon particles. In one embodiment, a small amount of at least one larger carbon particle and a larger amount of smaller carbon particles are generally included in the magnetic recording layer 32. In one embodiment, less than 2% of the carbon particles are considered large carbon particles. The large carbon particles generally have a size ranging from about 50 nm to about 500 nm, preferably from about 100 nm to about 300 nm. Spherical large carbon particle materials are known and commercially available, and in one embodiment include various additives, such as sulfur, etc., to improve performance. The smaller carbon particles generally have a particle length on the order of less than 100 nm, preferably less than about 75 nm. Other combinations of carbon particles of various sizes are also contemplated.

In order to improve the required characteristics, the preferred magnetic pigments may contain various additives, such as semi-metal or non-metal elements and their salts or oxides, such as Al, Co, Y, Ca, Mg, Mn, Na, and other suitable additives. The selected magnetic pigment may be treated with various auxiliary agents before it is dispersed in the binder system.

The head cleaning agent may be added to the magnetic recording layer 32 dispersion separately or may be dispersed within a binder system prior to addition to the magnetic recording layer 32 dispersion. In one embodiment, the head cleaning agent is aluminum oxide. Other abrasive grains, such as silica, ZrO₂, CrO₃, etc., can also be employed either alone or in mixtures with aluminum oxide or each other to form the head cleaning agent.

The binder system of the magnetic recording layer 32 incorporates at least one binder resin, such as a thermoplastic resin, in conjunction with other resin components, such as binders and surfactants used to disperse the head cleaning agent, a surfactant or wetting agent, and one or more hardeners. In one embodiment, the binder system of the magnetic recording layer 32 includes a combination of a primary polyurethane resin and a vinyl resin. Examples of polyurethanes include polyester-polyurethane, polyether-polyurethane, polycarbonate-polyurethane, polyester-polycarbonate-polyurethane, and polycaprolactone-polyurethane. The vinyl resin is frequently a vinyl chloride resin, a vinyl chloride-vinyl acetate copolymer, vinyl chloride-vinyl acetate-vinyl alcohol copolymer, vinyl chloride-vinyl acetate-maleic anhydride and the like. Resins such as bis-phenyl-A epoxide, styrene-acrylonitrile, and nitrocellulose may also be acceptable in certain magnetic recording medium formulations.

In an alternate embodiment, the vinyl resin is a non-halogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. In one embodiment, the nonhalogenated vinyl copolymer is a copolymer of monomers comprising 5 to 40 parts by weight of methacrylonitrile, 30 to 80 parts by weight of one or more nonhalogenated, nondispersing, vinyl monomers, 5 to 30 parts by weight of a nonhalogenated hydroxyl function, vinyl monomer, and 0.25 to 10 parts by weight of a nonhalogenated vinyl monomer bearing a dispersing group.

In one embodiment, the primary polyurethane binder is incorporated into the magnetic recording layer 32 in an amount of about 4 to about 10 parts by weight, and preferably about 6 to about 8 parts by weight, based on 100 parts by weight of the magnetic pigment, and the vinyl or vinyl chloride binder is incorporated in an amount of from about 8 to about 20 parts by weight, and preferably from about 14 to about 17 parts by weight, based on 100 parts by weight of the magnetic pigment.

In one example, the binder system further includes a head cleaning agent binder used to disperse the selected head cleaning agent material, such as a polyurethane binder in conjunction with a pre-dispersed or paste head cleaning agent. Use of other head cleaning agent binders compatible with the format of the selected head cleaning agent (e.g., powder head cleaning agent) is also contemplated.

In one embodiment, the magnetic recording layer 32 includes one or more lubricants such as a fatty acid and/or a fatty acid ester. The incorporated lubricant(s) exist throughout the magnetic side 14 including at the recording surface 36 of the magnetic recording layer 32. In general, the lubricant(s) reduce friction to maintain smooth contact with low drag and at least partially protects the recording surface 36 from wear. Thus, the lubricant(s) provided in both the magnetic recording layer 32 and the support layer 30 are selected and formulated in combination.

In one embodiment, fatty acid lubricants include stearic acid that is at least about 90% pure. Although technical grade acids and/or acid esters can also be employed for the lubricant component, incorporation of high purity lubricant materials ensures robust performance of the resultant medium. Other examples of acceptable fatty acids include myristic acid, palmitic acid, oleic acid, etc., and their mixtures. The upper layer formulation can further include a fatty acid ester such as butyl stearate, isopropyl stearate, butyl oleate, butyl palmitate, butylmyristate, hexadecyl stearate, and oleyl oleate. The fatty acids and fatty acid esters may be employed singly or in combination. In one embodiment, the lubricant is incorporated into the magnetic recording layer 32 in an amount from about 1 to about 10 parts by weight, and preferably from about 1 to about 5 parts by weight, based on 100 parts by weight of the magnetic pigment.

The conventional surfactant or wetting agent may be added separately to a magnetic recording layer dispersion including one or more of the above-identified components or added to the binder system prior to being added to the magnetic recording layer dispersion. In one embodiment, known surfactants, such as phenylphosphonic acid (PPA), 4-nitrobenzoic acid, and various other adducts of sulfuric, sulfonic, phosphoric, phosphonic, and carboxylic acids are utilized. In one embodiment, the binder system contains a hardening agent such as isocyanate or polyisocyanate. In one example, the hardener component is incorporated into the magnetic recording layer 32 in an amount of from about 2 to about 6 parts by weight, and preferably from about 3 to about 5 parts by weight, based on 100 parts by weight of the magnetic pigment.

The materials for the magnetic recording layer 32 are mixed together to form the magnetic recording layer dispersion. The magnetic recording layer dispersion is coated onto the upper surface 34 of the support layer 30 to form the magnetic recording layer 32. In one embodiment, solvents are added to the magnetic recording layer dispersion prior to coating the support layer 30 with the magnetic recording layer 32. For example, solvents associated with the magnetic recording layer 32 include cyclohexanone (CHO) with a concentration in the range of about 5% about 50%, methyl ethyl ketone (MEK) with a concentration in the range of about 30% to about 90%, and toluene (Tol) with a concentration in the range of about 0% and about 40%. Other solvents or solvent combinations including, for example, xylene, tetrahydrofuran, methyl isobutyl ketone, and methyl amyl ketone, may also be utilized.

In one embodiment, the coated and processed magnetic recording layer 32 has a final thickness from about 2 microinches (0.05 μm) to about 10 microinches (0.25 μm), preferably from about 2 microinches to about 5 microinches. In one embodiment, the magnetic recording layer 32 is formed to have a remanent magnetization-thickness product (Mr*t) of less than about 2.5 memu/cm², preferably less than about 2.1 memu/cm². The term “remanent magnetization—thickness product” refers to the product of the remanent magnetization after saturation in a strong magnetic field (796 kA/m) multiplied by the thickness of the magnetic coating.

“Orientation Ratio” refers to the ratio of remanent magnetization at zero applied magnetic field after saturation in a strong magnetic field (796 kA/m) measured in the direction parallel to that of the recording medium's intended transport to the corresponding quantity measured in the direction transverse (i.e., perpendicular, but in the plane of the magnetic recording medium) to that of the intended transport of the magnetic recording medium. In one embodiment, the fully processed magnetic recording layer 32 has an orientation ratio of greater than 2.2, preferably greater than 2.4.

The recording surface 36 of the magnetic recording layer 32 is formed with an average roughness (Rₐ) less than about 3.0 nm, preferably less than about 2.5 nm. The average roughness is the main height as calculated over the entire measured length or area. In one embodiment, the average roughness is calculated using the ANSI B46.1 standard. In one example the average roughness is determined using a Wyko® Optical Profilometer manufactured by Veeco Instruments, Inc., of Woodbury, N.Y. at 50× magnification.

The average surface peak-to-valley roughness (R_{z}) of the recording surface 36 is less than about 35 nm, preferably less than about 30 nm. The average peak-to-valley roughness is the average maximum profile of the ten greatest peak-to-valley separations in the evaluation area. The peak-to-valley separations are determined by measuring the distance from the top of a peak to the bottom of an adjacent valley. The average peak-to-valley roughness is useful for evaluation surface texture on limited-access surfaces, particularly where the presence of high peaks or deep valleys is of functional significance. In one example, the average surface peak-to-valley roughness is determined using a Wyko® Optical Profilometer manufactured by Veeco Instruments, Inc., of Woodbury, N.Y., at 50× magnification.

The Backside

In one embodiment, the backside or backside 16 primarily consists of a soft (i.e., Moh's hardness<5) non-magnetic particle material such as carbon black or silicon dioxide particles. In one embodiment, the backside 16 comprises a combination of two kinds of carbon blacks, including a primary, small carbon black component and a secondary, large texture carbon black component, in combination with appropriate binder resins. In one example, the primary, small carbon black component has an average particle size on the order from about 10 nm to about 25 nm, whereas the secondary, large carbon component has an average particle size on the order of from about 50 nm to about 300 nm. In one example, the backside 16 is of a type conventionally employed.

As is known in the art, pigments of the backside 16 dispersed as inks with appropriate binders, surfactant, ancillary particles, and solvents are typically purchased from a designated supplier. In a preferred embodiment, the backside binder includes at least one of the following: a polyurethane polymer, a phenoxy resin, or nitrocellulose added in an amount appropriate to modify coating stiffness as desired. The backside 16 is coated onto the bottom surface 20 of the substrate 12 to increase the durability of the magnetic recording medium 10.

Manufacturing Process

For manufacturing, each of the components of the support layer 30 are combined in a manner described above to form a coating to be applied to the substrate 12. Similarly, each of the magnetic recording layer 32 and the backside 16 are also mixed to form the respective coating mixtures, which are subsequently coated on the upper surface 34 of the support layer 30 and the bottom surface 20 of the substrate 12, respectively.

In one embodiment, the particular process for manufacturing of magnetic recording medium 10 includes an in-line portion and one or more off-line portions. The in-line portion includes unwinding the substrate 12 or other material from a spool or supply. The substrate 12 is coated with the backside 16 material on the lower surface 20 of substrate 12, and the backside 16 is dried, typically using conventional ovens. The magnetic side 14 is also applied to the substrate 12. For the dual-layer magnetic side 14, the support layer 30 is first applied directly to the substrate 12 and the magnetic recording layer 32 is then coated atop the support layer 30. Alternatively, the magnetic side 14 can be applied to the substrate 12 prior to application of the backside 16 to the substrate 12. In one embodiment, the support layer 30, magnetic layer 32, and backside 16 are applied to substrate 12 or each other using wet-on-wet, dual-slot, sequential dye, or other coating process.

The coated substrate 12 is magnetically orientated and dried, and then proceeds to the in-line calendering station. More specifically, the magnetic recording medium 10 is orientated by advancing the magnetic recording medium 10 through one or more magnetic fields to generally align the magnetic orientation of the metal particles of the magnetic recording layer 32 to have an orientation ratio greater than about 2.2, preferably greater than about 2.4. In one example, each magnetic field is formed by electric coils and/or permanent magnets.

According to one embodiment, manufacturing of the magnetic recording medium 10 includes compliant-on-steel (COS), in-line calendering. COS in-line calendering uses one or more in-line nip stations, in each of which a steel or other generally non-compliant roller contacts or otherwise is applied to the recording surface 36 and a rubberized or other generally compliant roll contacts or otherwise is applied to an outer surface of the backside 16 opposite the substrate 12. The generally non-compliant roll is applied to provide a desired degree of smoothness to the magnetically coated side of the substrate 12. In one embodiment, calendering further includes heating the rollers contacting the magnetic recording medium 10.

Alternatively or additionally, the in-line calendering includes “steel-on-steel” (SOS) calendering in which both opposing rolls are steel. The process may also employ one or more nip stations each having generally non-compliant rolls. After in-line calendering, the coated substrate 12 is wound. The process then proceeds to an off-line portion which occurs at a dedicated stand-alone machine. The magnetic recording medium 10 is unwound and calendered. The off-line calendering includes passing the magnetic recording medium 10 through a series of generally non-compliant rollers, e.g., multiple steel rollers, although other materials other than steel may be used to form the rollers. The magnetic recording medium 10 is then wound a second time. The wound roll of magnetic recording medium 10 is then split, burnished, and tested for defects according to methods known in the industry.

In one embodiment, the magnetic recording medium is calendered both in-line and off-line to achieve a magnetic recording surface 36 having an average surface roughness of less than about 3.0 nm, preferably less than about 2.5 nm, and an average surface peak-to-valley roughness of less than about 35 nm, preferably less than about 30 nm. In one embodiment, the desired level of surface roughness and/or average surface peak-to-valley roughness is obtainable in part due to the compressibility of the support layer 30 achieved by the level of pigments included in the support layer 30 as described above.

A magnetic recording medium according to the embodiments of the present invention provides a recording surface with improved smoothness characteristics as compared to prior art magnetic recording mediums. In particular, the magnetic recording media described herein generally exhibit increased signal-to-noise ratios and decreased dropout levels. These parameters are of increasing importance as magnetic recording media in the form of magnetic recording tapes continue to be formed with higher recording density and with smaller track widths. Accordingly, not only does the magnetic recording medium described herein present an improved medium for use with low density recording applications, but also provides a magnetic recording medium configured for reliable use in high density recording applications.

Although specific embodiments have been described herein for purposes of description of the preferred embodiment, it will be appreciated by those of ordinary skill in the art that a wide variety of alternate and/or equivalent implementations calculated to achieve the same purposes may be substituted for the specific embodiments described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLES

The following Table 1 lists the physical attributes of the magnetic recording surface as well as the recording attributes: skirt SNR, BBSNR, small dropouts, and large dropouts of the magnetic recording medium determined for an example magnetic recording medium and a comparative example magnetic recording medium. The physical attributes, namely the average roughness (Rₐ) and the average surface peak-to-valley ratio (R_{z}) were measured with a Wyko® Optical Profilometer manufactured by Veeco Instruments, Inc., of Woodbury, N.Y., at 50× magnification. The Skirt SNR, BBSNR, small dropout, and large dropout values listed in Table 1 were measured according to ECMA International Standard 319. The Skirt SNR and BBSNR values were determined using a reel-to-reel tester with a 10 μm read/write head designed for 3937 frpmm writing at 5187 frpmm. The dropout values were determined at a 55% threshold using a reel-to-reel tester with a 10 μm read/write head designed for 3937 frpmm writing at 3660 frpmm. The small and large dropout values expressed represent the number of the respective dropouts detected per meter length of the magnetic recording medium.

Table 1 not only illustrates that Example 1 has a smoother surface profile of the magnetic recording surface (Rₐ and R_{z}), but also indicates improved (i.e., increased) signal-to-noise ratios and improved (i.e., decreased) dropout occurrences relative to the surface profile, signal-to-noise ratios, and dropouts of Comparative Example C1.

Table 2 illustrates some similar attributes as illustrated in Table 1. In particular, Table 2 demonstrates that use of a smaller magnetic particle in the magnetic recording tape of Example 2 improves (i.e., increases) the BBSNR relative to the magnetic recording tape of Comparative Example C2, which uses relatively larger particles.

Table 3 lists the physical attribute of the magnetic recording surface as well as recording attributes of the magnetic recording medium, namely the Skirt SNR, BBSNR, small dropouts, and larger dropouts, determined for an example magnetic recording medium and a comparative example of commercially available Ultrium LTO 3 magnetic recording medium. The physical attributes, namely the average roughness (Rₐ) and the average surface peak-to-valley ratio (R_{z}) were measured with a Wyko® Optical Profilometer manufactured by Veeco Instruments, Inc., of Woodbury, N.Y., at 50× magnification. The Skirt SNR, BBSNR, small dropout, and large dropout values listed in Table 3 were measured according to EMCA International Standard 319. The Skirt SNR and BBSNR values were determined using a reel-to-reel tester with a 6.0 μm read/write head writing at 5187 frpmm. The small and large dropout values expressed represent the number of the respective dropouts detected at a 35% threshold per meter length of the magnetic recording medium.

Table 3 demonstrates improved (i.e., increased) signal-to-noise ratios and improved (i.e. decreased) dropout occurrences of magnetic recording of Example 3 relative to the commercially available Ultrium LTO 3 used for Comparative Example 3.

TABLE 1

| | | | Skirt | | Small | Large |
|---|---|---|---|---|---|---|
| | | | SNR | BBSNR | Dropouts | Dropouts |
| Example | Rₐ (nm) | R_{z} (nm) | (dB)¹ | (dB)¹ | (per m) | (per m) |
| 1 | 2.30 | 23.35 | 0.92 | 0.63 | 0.11 | 0.27 |
| C1 | 3.03 | 42.72 | 0.00 | 0.00 | 0.24 | 0.90 |

| | Metal | Magnetic | | | | Magnetic |
|---|---|---|---|---|---|---|
| | Particle | Layer | | | | Side |
| | Length | Pigment | Sigma-S | Mr * t | Orientation | Resistivity |
| Example | (nm) | Concentration | (Am²/kg) | (memu/cm²) | Ratio | (ohms/cm²) |
| 1 | 45 | 40% | 117 | 1.99 | 2.74 | 3.8 E6 |
| C1 | 45 | 40% | 117 | 2.02 | 2.72 | 5.9 E6 |

¹Skirt SNR and BBSNR values measured relative to Comparative Example C1.

### Example 1

Example 1 in Table 1 is a dual-layer magnetic recording medium in the form of a magnetic recording tape comprising a magnetic recording layer and non-magnetic support layer coated on a top surface of a 4.5 μm PEN substrate. In addition, the magnetic recording tape has a backside coated on a bottom surface (i.e., a surface opposite the top surface) of the substrate.

Both the magnetic recording layer and the support layer use a binder system comprising a commercially available PVC-vinyl copolymer (MR 104) and a commercially available polyurethane (UR-4122) polymer. In addition to the binders, each formulation contains a mixture of fatty acid (stearic acid) and fatty acid esters (butyl stearate and butyl palmitate) as lubricants, alumina as a head cleaning agent, and carbon particles. The magnetic particles of the magnetic recording layer of this example are acicular metal particles with a long axis length of about 45 nm and coercivity of about 199 kA/m (2500 Oe).

Magnetic orientation of the magnetic recording layer was carried out in a conventional manner by passing the coated magnetic recording tape through a series of inductive coil magnets such that the magnetic recording layer and the support layer coatings were dried to a non-mobile state while in the magnetic field created by the inductive coil magnets. After drying, the tape was in-line steel-on-steel calendered, followed by off-line steel-on-steel calendering.

### Comparative Example C1

The magnetic recording medium of Comparative Example C1 in Table 1 was prepared from dispersions and coated similar to magnetic recording medium of Example 1. The magnetic recording tape of Comparative Example C1 was in-line steel-on-steel calendered, but no off-line calendering was performed.

TABLE 2

| | Metal | Magnetic | | | | |
|---|---|---|---|---|---|---|
| | Particle | Layer | | | | |
| | Length | Pigment | Sigma-S | Mr * t | Orientation | BBSNR |
| Example | (nm) | Concentration | (Am/kg) | (memu/cm²) | Ratio | (dB)² |
| 2 | 43 | 43.7% | 113 | 1.92 | 2.33 | 1.92 |
| C2 | 60 | 44.4% | 126 | 1.92 | 2.45 | 0.00 |

²BBSNR values measured relative to Comparative Example C2.

### Example 2

The dual-layer magnetic recording medium of Example 2 is a magnetic recording tape prepared from dispersions and coated similar to the magnetic recording tape of Example 1. The magnetic particles of the magnetic recording layer of this example are acicular metal particles with a long axis length of about 43 nm and coercivity of about 185 kA/m (2300 Oe). The magnetic recording tape of Example 2 was in-line steel-on-steel calendered, but no off-line calendering was performed.

### Comparative Example C2

The dual-layer magnetic recording medium of Comparative Example C2 is a magnetic recording tape prepared from dispersions and coated similar to the magnetic recording tape of Example 1. The magnetic particles of the magnetic recording layer of this example are acicular metal particles with a long axis length of about 60 nm and coercivity of about 194 kA/m (2440 Oe). The magnetic recording tape of Comparative Example C2 was in-line steel-on-steel calendered, but no off-line calendering was performed.

TABLE 3

| | | | Skirt | | Small | Large |
|---|---|---|---|---|---|---|
| | | | SNR | BBSNR | Dropouts | Dropouts |
| Example | Rₐ (nm) | R_{z} (nm) | (dB)³ | (dB)³ | (per m) | (per m) |
| 3 | 2.30 | 23.35 | 1.04 | 1.56 | 0.19 | 0.91 |
| C3 | 2.90 | 29.40 | 0.00 | 0.00 | 2.01 | 1.45 |

³Skirt SNR and BBSNR values measured relative to Comparative Example C3.

### Example 3

The dual-layer magnetic recording medium of Example 3 is a magnetic recording tape prepared from dispersions and coated similar to the magnetic recording tape of Example 1. The magnetic particles of the magnetic recording layer of this example are acicular metal particles with a long axis length of about 45 nm and coercivity of about 199 kA/m (2300 Oe). The magnetic recording tape of Example 3 was in-line steel-on-steel calendered, followed by off-line steel-on-steel calendering.

### Comparative Example C3

The dual-layer magnetic recording medium of Comparative Example C3 is a commercially available magnetic recording tape, namely an Ultrium LTO 3 magnetic recording tape. The resistivity of such magnetic recording media has been measured to generally range from about 9.1×10⁵ ohms/square to about 3.1×10⁸ ohms/square.

What is claimed is:

1. A magnetic recording medium comprising:
a substrate defining a first surface;
a support layer formed over the first surface of the substrate; and
a magnetic recording layer formed over the support layer and including magnetic metal particles, the magnetic recording layer having a resistivity less than about 1×10⁸ ohms/square and further defining a recording surface opposite the support layer, wherein the recording surface has an average roughness of less than about 2.5 nm.

2. The magnetic recording medium of claim 1, wherein the resistivity is less than about 5×10⁷ ohms/square.

3. The magnetic recording medium of claim 1, wherein the recording surface defines an average surface peak-to-valley roughness less than about 35 nm.

4. The magnetic recording medium of claim 3, wherein the average surface peak-to-valley roughness is less than about 30 nm.

5. The magnetic recording medium of claim 1, wherein the magnetic metal particles each have a long axis length less than about 75 nm.

6. The magnetic recording medium of claim 5, wherein the magnetic metal particles each have a long axis length less than about 50 nm.

7. The magnetic recording medium of claim 5, wherein the magnetic metal particles of the magnetic side have an orientation ratio greater than about 2.2.

8. The magnetic recording medium of claim 7, wherein the orientation ratio is greater than about 2.4.

9. The magnetic recording medium of claim 1, wherein the magnetic side has a remanent magnetization less than about 2.5 memu/cm².

10. The magnetic recording medium of claim 9, wherein the remanent magnetization is less than about 2.1 memu/cm².

11. The magnetic recording medium of claim 1, wherein the magnetic recording layer has a coercivity of at least about 183 kA/m.

12. The magnetic recording medium of claim 1, wherein the magnetic recording layer has a volume concentration of magnetic metal particles greater than 35%.

13. The magnetic recording medium of claim 12, wherein the magnetic recording layer has a volume concentration of magnetic metal particles greater than 40%.

14. The magnetic recording medium of claim 1, wherein the support layer includes primary pigment particles having a primary particle length less than about 150 nm, and the support layer has a volume concentration of iron oxide greater than about 35%.

15. The magnetic recording medium of claim 14, wherein the primary pigment particles of the support layer have a primary particle length less than about 120 nm, and the support layer has a volume concentration of primary pigment particles greater than about 40%.

16. The magnetic recording medium of claim 1, wherein the support layer comprises:
a plurality of primary pigment particles, and
a plurality of carbon black particles at a concentration between about 4 parts and about 10 parts per 100 parts per unit weight of the plurality of primary pigment particles.

17. The magnetic recording medium of claim 16, wherein the concentration of the plurality of carbon black particles in the support layer is between about 5 parts and about 8 parts per 100 parts per unit weight of the plurality of primary pigment particles.

18. A magnetic recording medium comprising:
a substrate defining a first surface;
a support layer formed over the first surface; and
a magnetic side formed over the support layer, the magnetic side having a resistivity less than about 1×10⁸ ohms/square and further defining a recording surface, wherein the recording surface has an average surface peak-to-valley roughness less than about 35 nm.

19. The magnetic recording medium of claim 18, wherein the recording surface has an average roughness less than about 2.5 nm.
